(19) United States
(12) Patent Application Publication
(10) Pub. No.: US 2012/0249439 A1
(43) Pub. Date: Oct. 4, 2012

(54) MOBILE ELECTRONIC DEVICE

(76) Inventor: Takashi KAWATE, Yokohama (JP)

(21) Appl. No.: 13/247,649

(22) Filed: Sep. 28, 2011

(30) Foreign Application Priority Data
Sep. 28, 2010 (JP) 2010-217946

(51) Int. Cl. G06F 3/041

(52) U.S. Cl. 345/173

(57) ABSTRACT

A mobile electronic device includes a chassis, a touch panel, a controller, and a communication part. If the communication part is in the middle of a communication process, the controller causes a prescribed menu button to be displayed at a prescribed first position on the touch panel, and when a contact input on the menu button is detected, the controller causes a prescribed confirmation button to be displayed at a second position on the touch panel part which is different from the first position, and when a contact input on the confirmation button is detected, the controller executes a function corresponding to the menu button. The touch panel is exposed on the surface of the chassis and detects contact input from an external source, and displays display content corresponding to the contact input. The controller controls the display content on the touch panel. The communication part realizes wireless communication.

### CROSS-REFERENCE TO RELATED APPLICATION

The present application claims priority under 35 U.S.C. §119 to Japanese Patent Application No. 2010-217946, filed on Sep. 28, 2010, entitled “MOBILE ELECTRONIC DEVICE”. The content of which is incorporated by reference herein in its entirety.

### FIELD

Embodiments of the present disclosure relate generally to a mobile electronic device.

### BACKGROUND

Mobile electronic device comprising a touch panel part face the problem that, when the ear or face of the user comes into contact with the touch panel part during communication, the touch panel part detects this contact as an input operation, causing an erroneous operation to occur.

### SUMMARY

A mobile electronic device is disclosed. The mobile electronic device includes a chassis, a touch panel part, a main control part, and a communication part. If the communication part is in the middle of a communication process, the main control part causes a prescribed menu button to be displayed at a prescribed first position on the touch panel part, and when a contact input on the menu button is detected, the main control part causes a prescribed confirmation button to be displayed at a second position that is on the touch panel part and is different from the first position, and when a contact input on the confirmation button is detected, the main control part executes a function corresponding to the menu button. The touch panel part that is exposed on the surface of the chassis and detects contact input from an external source, and displays display content corresponding to the contact input. The main control part that controls the display content on the touch panel part. The communication part that realizes wireless communication.

A mobile electronic device is disclosed. The mobile electronic device includes a chassis, a touch panel part, a main control part, an application control part, and a communication part. If the communication part is on standby and the application programs are not active, the main control part causes a prescribed menu button to be displayed at a prescribed first position on the touch panel part, and when a contact input on the menu button is detected, the main control part causes a prescribed confirmation button to be displayed at a second position that is on the touch panel part and is different from the first position, and when a contact input on the confirmation button is detected, the main control part executes a function corresponding to the menu button. The touch panel part that is exposed on the surface of the chassis and detects contact input from an external source, and displays display content corresponding to the contact input. The main control part that controls the display content on the touch panel part. The communication part that realizes wireless communication.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1 is a diagrammatic perspective view showing a mobile electronic device according to an embodiment of the present invention.

FIG. 2 is a functional block diagram showing the mobile electronic device described in FIG. 1.

FIG. 3 is a flowchart showing the actions of the mobile electronic device described in FIG. 1.

FIG. 4 is an explanatory diagram showing the actions of the mobile electronic device described in FIG. 1.

FIG. 5 is an explanatory diagram showing the actions of the mobile electronic device described in FIG. 1.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. Furthermore, there is no intention to be bound by any expressed or implied theory presented in the preceding field, background, summary or the following detailed description. The present disclosure should be accorded scope consistent with the claims, and not limited to the examples described and shown herein.

Embodiments of the disclosure are described herein in the context of one practical non-limiting application, namely, an information device. Embodiments of the disclosure, however, are not limited to such mobile information devices, and the techniques described herein may also be utilized in other applications. For example, embodiments may be applicable to mobile phones, digital books, digital cameras, electronic game machines, digital music players, personal digital assistance (PDA), personal handy phone system (PHS), lap top computers, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

The following is a detailed description of the present invention, with reference to the drawings. It should be noted that the present invention is not limited by the present embodiment. Some of the components of the present embodiment are substitutable and obvious but maintain the identity of the invention. The multiple modified examples described in the present embodiment may be freely combined within an obvious scope by a person skilled in the art.

[Mobile Electronic Device]

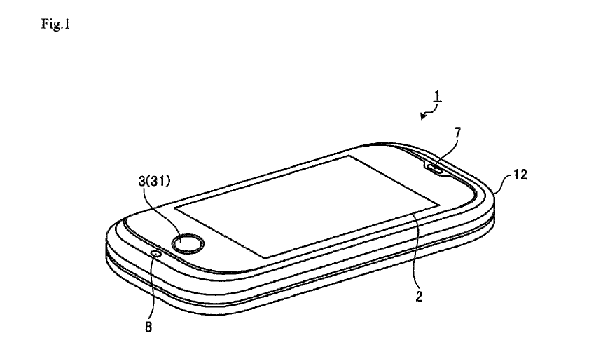

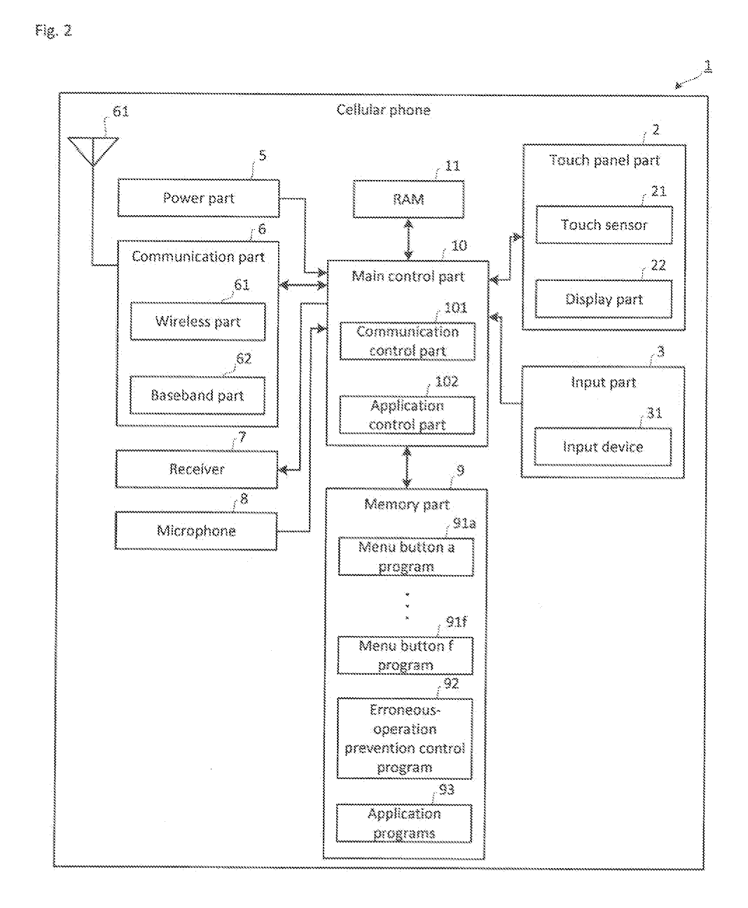

FIG. 1 is a diagrammatic perspective view showing a mobile electronic device according to an embodiment of the present invention. FIG. 2 is a functional block diagram showing the mobile electronic device described in FIG. 1.

This mobile electronic device 1 is applied to, for example, a cellular phone, a PHS (Personal Handy-phone System), a PDA (Personal Digital Assistant), a portable navigation device, a personal computer, or a gaming device. In the description of the present embodiment, the mobile electronic device 1 is applied to a cellular phone (refer to FIG. 1).

This mobile electronic device 1 comprises a touch panel part 2, an input part 3, a substrate (not illustrated), a power part 5, a communication part 6, a receiver 7, a microphone 8, a memory part 9, a main control part 10, and a RAM (Random Access Memory) 11, and is configured by building these components into a chassis 12 (refer to FIG. 1 and FIG. 2). In the present embodiment, the mobile electronic device 1 has a handy-sized tablet shape.

The touch panel part 2 is a panel with an input function and a display function, and is configured by a touch sensor 21 and a display part 22. In the present embodiment, the touch panel 2 is arranged to be exposed on the widest flat surface on the tablet-shaped chassis 12. The touch sensor 21 is a sensor that detects contact input on the touch panel part 2, and executes the input function of the touch panel part 2. This touch sensor 21 is able to detect the contact position and contact movement as the contact input. Examples of contact movements include a touch movement, a release movement, a tap movement, a sweeping movement, a flicking movement and a pinching movement. Contact input on the touch sensor 21 is performed using, for example, a finger, a stylus or a pen. For the touch sensor 21, a heretofore known pressure-sensitive or electrostatic sensor may be adopted, for example. The display part 22 is a part that displayed prescribed display content, and realizes the display function of the touch panel part 2. This display part 22 is able to display, for example, characters, graphics, symbols or images as display content. For the display panel 22, a heretofore known liquid crystal display or organic EL (organic electro-luminescence) display panel may be adopted, for example.

The input part 3 has an input function independent from the touch panel part 2. For this input part 3, a button-type hard key or a pressure-sensitive or electrostatic input device may be adopted, for example. For example, in the present embodiment, the input part 3 is an unlock key that detects a pressing movement as external input and outputs a signal thereof to the main control part 10. The input part 3 is arranged on a longitudinal end of the chassis 12 lateral to the touch panel part 2.

The substrate (not illustrated) is a circuit substrate on which electronic components for realizing, for example, the memory part 9, the main control part 10 and the RAM (Random Access Memory) 11 are mounted, and is housed inside the chassis 12. In the present embodiment, the substrate is arranged on a layer below the touch panel part 2. The substrate is electrically connected to other components (the touch panel part 2, the input part 3, the power part 5, the communication part 6, the receiver 7 and the microphone 8) via wiring.

The power part 5 supplies power obtained from a storage battery or an external battery. The communication part 6 comprises an antenna 61, and realizes wireless communication (telephone communication or information communication) with a base station by establishing a wireless signal circuit (e.g., a CDMA [Code Division Multiple Access] circuit with the base station) via a channel assigned by the base station. For example, in the present embodiment, the communication part 6 comprises a wireless part 61 that realizes wireless communication, and a baseband part 62 that realizes baseband transmission. The receiver 7 outputs the other part's voice during telephone communication or a ringtone, etc. The microphone 8 converts the voice of the user, etc. into electrical signals. In the present embodiment, the receiver 7 and the microphone 8 are respectively arranged on each of the longitudinal ends of the chassis 12 lateral to the touch panel part 2.

The memory part 9 is, for example, a non-volatile memory or a magnetic storage device, and stores programs and data used for the processes of the main control part 10. For example, in the present embodiment, the memory part 9 stores menu-button programs 91a-91f that realize the functions of each menu button a-f displayed on the touch panel part 2 during telephone communication, an erroneous-operation prevention control program 92 for executing erroneous-operation prevention control (described below) for the touch panel part 2 during communication, and an application program 93 for executing various applications, etc. In addition, the memory part 9 stores function programs that realize general functions such as an E-mail function and a browser function, operating-system programs that realize basic functions of the mobile electronic device 1, and address-book data registering the names, telephone numbers and E-mail addresses of users, etc.

The main control part 10 is, for example, a CPU (Central Processing Unit), and performs overall control of the operations of the mobile electronic device 1. For example, the main control part 10 executes programs stored in the memory part 9 while referring to data stored in the memory part 9 whenever necessary. As a result, the touch panel part 2, the input part 3 and the communication part 6, etc. are controlled, and the various functions of the mobile electronic device 1 are realized. The main control part 10 temporarily stores data that are acquired, generated and/or processed as a result of the execution of a program or process read from the memory part 9 in the RAM 11. In the present embodiment, the main control part 10 comprises a communication control part 101 that controls the communication part 6, and an application control part 102 that controls various application programs 93. The main control part 10 may download the above programs and data from an external server device via wireless communication performed by the communication part 6.

Furthermore, in addition to the above components, the mobile electronic device 1 comprises a connector, a wiring part, an earth electrode, and a joining terminal, etc., and also comprises members or instruments for executing various functions (not illustrated).

In the mobile electronic device 1, when the touch panel part 2 or the input part 3 detects an input operation from an external source (i.e., a touch operation on the touch panel part 2, or a pressing operation on the input part 3), the main control part 10 performs a process corresponding to this input operation (refer to FIG. 2). For example, when multiple menu buttons are displayed on the touch panel part 2 and the user selects any menu button and performs a touch operation, the main control part 10 reads and executes the programs 91a-91f, 92 corresponding to the menu button related to the touch operation from the memory part 9. As a result, a process corresponding to the touch operation of the user is performed.

During telephone communication (during communication), the communication part 6 establishes a wireless signal circuit via the antenna 61, and the main control part 10 performs the input and output of audio via the receiver 7 and the microphone 8, thus allowing the user to make a telephone call.

[Erroneous-Operation Prevention Control for the Touch Panel Part During Telephone Communication]

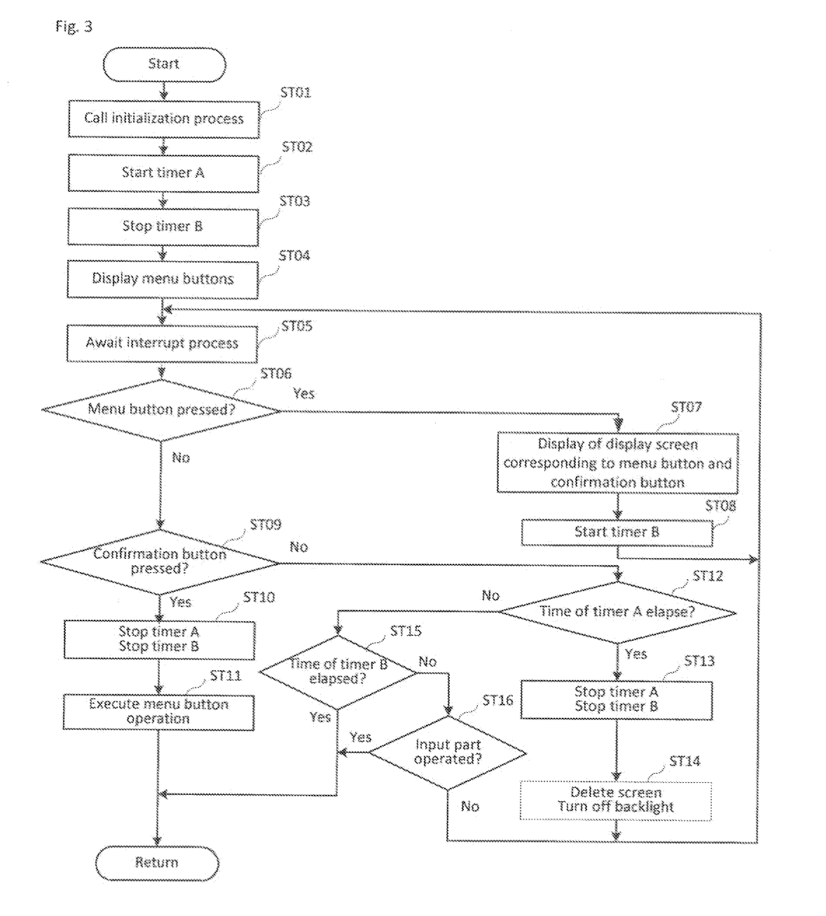

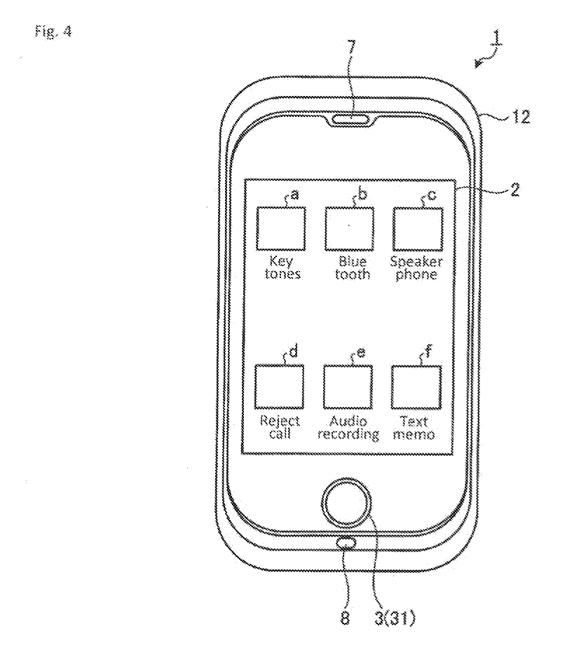

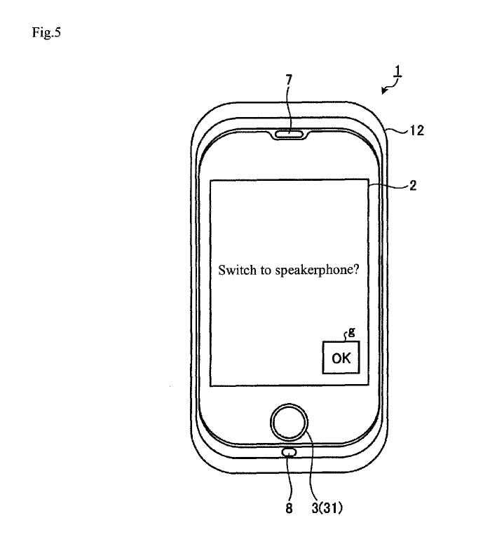

FIGS. 3 through 5 are a flowchart (FIG. 3) and explanatory diagrams (FIG. 4 and FIG. 5) showing the actions of the mobile electronic device described in FIG. 1.

In this mobile electronic device 1, during telephone communication, the menu buttons a-f for telephone communication are displayed on the touch panel part 2 (refer to FIG. 4). Then, when the user selects any menu button from among these menu buttons a-f and performs a touch operation, the main control part 10 executes a process corresponding to the touch operation.

Here, in a general mobile electronic device comprising an electrostatic touch panel part, there is the problem that when the ear or face of the user comes into contact with the touch panel part during telephone communication, the touch panel part detects this as an input operation, causing an erroneous operation to occur.

Therefore, in the mobile electronic device 1, control is performed to prevent erroneous operations of the touch panel part 2 during telephone communication (refer to FIG. 3). For example, in the present embodiment, when telephone communication is started, the main control part 10 reads and executes the erroneous-operation prevention control program 92 from the memory part 9 to perform the following control.

In step ST01, a call initialization process is performed. This call initialization process includes, for example, a deleting process for the display of the display screen and the confirmation button g corresponding to the pressed menu button c (described below) (step ST07), and an end process for the executed function of the menu button C. After this step ST01, the process proceeds to step ST02.

In step ST02, the timer A starts. This timer A is used for prescribing the waiting time for executing processes for screen deletion of the touch panel part 2 and turning the backlight off (described below) (step ST14). In the present embodiment, the main control part 10 performs ON/OFF (start/stop) operations for the timer A, and the set time of the timer A is set to 1 minute. After this step ST02, the process proceeds to step ST03.

In step ST03, a timer B is stopped (reset). This timer B is a timer that is independent from the timer A, and is used for prescribing the waiting time for returning to the call initialization process (step ST01) when the confirmation button g (described below) is not pressed. In the present embodiment, the main control part 10 performs ON/OFF operations of the timer B, and the set time of the timer B is set to 5 seconds. After this step ST03, the process proceeds to step ST04.

In step ST04, the menu buttons a-f are displayed on the touch panel part 2 (refer to FIG. 4). These menu buttons a-f are buttons related to functions that may be used during telephone communication. For example, in the present embodiment, icons corresponding to functions for key tones, Blue tooth, speaker phone, call rejection, audio recording and text memo are displayed on the touch panel part 2. The menu buttons a-f are arranged in two rows across the entire region of the screen of the touch panel part 2. After this step ST04, the process proceeds to step ST05.

In step ST05, the device awaits interrupt processing (i.e., enters a standby state) until an operational input from the user. After this step ST05, the process proceeds to step ST06.

In step ST06, a determination is made as to whether any of the menu buttons a-f have been pressed. The menu buttons a-f may be pressed intentionally by the user, or by accident through contact with the ear or face of the user. For example, in the arrangement configuration of the menu buttons a-f in the present embodiment, the ear or face of the user during a call may easily come into contact with the menu buttons a-c that are near the receiver 7. Here, when the touch panel part 2 (the touch sensor 21) detects pressing of the menu buttons a-f, a positive determination is made regardless of whether the operation was intentional by the user. In this step ST06, if a positive determination is made the process proceeds to step ST07, and if a negative determination is made the process proceeds to step ST09.

In step ST07, a display screen corresponding to the pressed menu button is displayed on the touch panel part 2, and the confirmation button g is displayed on the touch panel part 2 (refer to FIG. 5). As a result, the device enters a standby state for the execution of a program corresponding to the pressed menu button. For example, in the present embodiment, because the menu button C for the speakerphone has been pressed, a display screen stating “Would you like to switch to speakerphone?” is displayed on the touch panel part 2. At the same time, the confirmation button g stating “OK” is also displayed, and the device enters a standby state for the execution of the menu-button program 91c corresponding to the menu button c.

Here, the confirmation button g is displayed to confirm whether the menu button c was pressed intentionally by the user. Therefore, the confirmation button g is preferably displayed at a position that is on the touch panel part 2 and is unlikely to generate an erroneous operation by the user during telephone communication. Moreover, the confirmation button g is preferably displayed at a position different from the display position of the pressed menu button c (refer to FIG. 4). For example, in the present embodiment, the touch panel part 2, the receiver 7 and the microphone 8 are arranged close to one other on the same surface of the chassis 12. The touch panel part 2 is arranged between the receiver 7 and the microphone 8. As a result, during telephone communication, it is easy to come into contact with the menu buttons a-c that are close to the receiver 7. Therefore, the confirmation button g is displayed at a position on the touch panel part 2 that is removed from the receiver 7 and is relatively far from the receiver 7 (i.e., a position closer to the microphone 8 than to the receiver 7) (refer to FIG. 5). If the menu button c that is located in the region of the touch panel part 2 toward the receiver 7 is pressed, the confirmation button g is displayed in the region of the touch panel part 2 toward the microphone 8. After this step ST07, the process proceeds to step ST08.

In step ST08, the timer B starts. After this step ST08, the process returns to step ST05.

In step ST09, a determination is made as to whether the confirmation button g has been pressed. Because the display position of the confirmation button g is designed as described above, any pressing of the confirmation button g may be presumed to be intentional on the part of the user. In this step ST09, if a positive determination is made the process proceeds to step ST10, and if a negative determination is made the process proceeds to step ST12.

In step ST10, the timer A and the timer B are stopped (reset). After this step ST10, the process proceeds to step ST11.

In step ST11, the program 91c corresponding to the pressed menu button c is executed. For example, in the present embodiment, a display screen corresponding to the menu button c for speakerphone is displayed, and the program 91c corresponding to the menu button c is being executed. After this step ST11, the process returns to step ST01.

In step ST12, a determination is made as to whether the set time (1 minute) of the timer A has passed. In this step ST12, if a positive determination is made the process proceeds to step ST13, and if a negative determination is made the process proceeds to step ST15.

In step ST13, the timer A and the timer B are stopped (reset). After this step ST13, the process proceeds to step ST14.

In step ST14, the display screen of the touch panel part 2 is deleted, and the backlight (not illustrated) is turned off. At the same time, the keys are locked, and contact input into the input part 3 is prohibited (i.e., the main control part 10 does not perform processes for contact input on the touch panel part 2) unless a long-press operation on the input part 3 (positive determination in step ST16) is performed. After this step ST14, the process returns to step ST05.

In step ST15, a determination is made as to whether the set time (5 seconds) of the timer B has passed. In this step ST15, if a positive determination is made the process returns to step ST01, and if a negative determination is made the process proceeds to step ST16.

In step ST16, a determination is made as to whether a prescribed operation has been performed on the input part 3. For example, in the present embodiment, a long-press operation on the input part 3 is assigned as an unlock operation, and when this long-press operation is performed, a positive determination is made. In this step ST16, if a positive determination is made the process returns to step ST01, and if a negative determination is made the process returns to step ST05.

In the present embodiment, multiple menu buttons a-f are displayed on the touch panel part 2 (refer to FIG. 4). However, without being limited to this, a single menu button may be displayed alone (not illustrated).

Moreover, in the present embodiment, the menu button c and the confirmation button g receiving contact input are mutually different buttons (refer to FIG. 4 and FIG. 5). However, without being limited to this, the menu button c and the confirmation button g receiving contact input may be, for example, the some button (e.g., characters, graphics, symbols, images, etc.) (not illustrated). For example, when the menu button c is pressed, this menu button c may be moved from the initial display position to a prescribed display position.

In the present embodiment, 6 menu buttons a-f are divided into two levels and displayed on the touch panel part 2 (refer to FIG. 4). Then, in a planar perspective of the touch panel part 2 in which the receiver 7 is on the upper side and the microphone 8 is on the lower side, when the menu button c in the top-right region of the touch panel part 2 is pressed, the confirmation button g is set to be displayed in the bottom-right region (the position of the menu button f) of the touch panel part 2 (refer to FIG. 5). At this time, when any of the menu buttons a-f is pressed, the confirmation button g is set to be displayed at a fixed position on the touch panel part 2.

However, without being limited to this, the confirmation button g may be displayed at a prescribed display position different from the display position of the pressed menu button in response to the pressed menu button (not illustrated). For example, in FIG. 4, the menu button a (b) is pressed, the confirmation button g may be displayed at the position of the menu button d (e), and conversely, if the menu button d (e) is pressed, the confirmation button g may be displayed at the position of the menu button a (b). In other words, the display position of the confirmation button g need only be a position different from the display position of the pressed menu button a-f (i.e., a position far enough removed to prevent continuous erroneous operations caused by similar factors).

In other words, when the touch panel part 2 is bisected into the display region on the side of the receiver 7 and the display region on the side of the microphone 8, the confirmation button is displayed in the display region different from the display region of the pressed menu button c (refer to FIG. 4 and FIG. 5). As a modified example, if one of the menu buttons d-f in the display region on the side of the microphone 8 is pressed, the confirmation button g may be displayed in the display region on the side of the receiver 7. At the same time, if one of the menu buttons c, f (a, d) in the display region on the right side (left side) of FIG. 4 is pressed, the confirmation button g may be displayed in the display region on the left side (right side) of FIG. 4. Furthermore, if the menu button c (a) in the display region on the top-right side (top-left side) of FIG. 4 is pressed, the confirmation button g may be displayed in the region diagonally opposite on the touch panel part 2 (i.e., in the display region on the bottom-left side [bottom-right side] of FIG. 4).

In the present embodiment, erroneous-operation prevention control for the touch panel part during telephone communication has been described, but without being limited to this, similar control may be performed during other types of wireless communication, such as information communication. For example, the above control may be performed in states of communication or standby during information communication.

Moreover, in the present embodiment, when a menu button c is pressed, the display screen corresponding to the pressed menu button c and the confirmation button g are displayed after deleting the menu buttons a-f of the initial screen (refer to FIG. 4) (positive determination in step ST06, and step ST07) (refer to FIG. 5). However, without being limited to this, when one of the menu buttons is pressed, the confirmation button g may be displayed while continuing to display the menu buttons a-f of the initial screen (not illustrated).

As described above, this mobile electronic device 1 comprises: the chassis 12; the touch panel 2 that is exposed on the surface of this chassis 12 and detects contact input (touch operations) from an external source, and displays display content corresponding to the contact input; and a main control part 10 (control part) that controls the display content of this touch panel part 2 (refer to FIG. 1 and FIG. 2). The main control part 10 causes the prescribed menu buttons a-f to be displayed at a prescribed first position on the touch panel part 2 (step ST04) (refer to FIG. 3 and FIG. 4). When contact input (either intentional contact input by the user, or contact input resulting from an erroneous operation) on the menu button c is detected, the main control part 10 causes the prescribed confirmation button g to be displayed at a second position that is on the touch panel part 2 and is different from the first position (positive determination in step ST06, and step ST07) (refer to FIG. 5). Then, when contact input on the confirmation button g is detected, the main control part 10 executes a function corresponding to the menu button c receiving contact input (positive determination in step ST09, and step ST11).

In this configuration, when there is contact input on the menu button c, the confirmation button g thereof is displayed, making it possible to confirm the intention of the user with regard to the contact input. As a result, there is the advantage that it is possible to prevent erroneous operations on the touch panel part caused by the user. Moreover, at this time, because the menu button c and the confirmation button g receiving contact input are displayed at mutually different positions, compared to a configuration in which these buttons are displayed at the same position (not illustrated), there is the advantage that it is possible to effectively prevent erroneous operation on the touch panel part caused by similar factors.

Moreover, in this configuration, compared to a configuration in which, for example, a proximity sensor is mounted to detect the proximity of the ear or face of the user (not illustrated), there is the advantage that it is possible to reduce the number of parts and the manufacturing cost. Moreover, compared to a configuration in which, for example, all of the menu buttons are displayed at a position unlikely to cause erroneous operations from the start during telephone communication (not illustrated), there is the advantage that it is possible to secure a broad degree of freedom for the arrangement and design of the menu buttons a-f in the touch panel part 2.

Moreover, the mobile electronic device 1 comprises the communication part 6 that realizes wireless communication (telephone communication and information communication) (refer to FIG. 2). When contact input on the confirmation button g is detected when the communication part 6 is in communication or on standby, the main control part 10 executes a function corresponding to the menu button c receiving the contact input (positive determination in step ST09, and step ST11) (refer to FIG. 3).

In this configuration, because the above control is performed during wireless communication, when erroneous operations may easily occur, there is the advantage that it is possible to effectively prevent erroneous operations on the touch panel part 2.

Moreover, the mobile electronic device 1 comprises the communication part 6 that realizes telephone communication (refer to FIG. 2). When contact input on the confirmation button g is detected when the communication part 6 is in communication, the main control part 10 executes a function corresponding to the menu button c receiving the contact input (positive determination in step ST09, and step ST11) (refer to FIG. 3).

In this configuration, because the above control is performed during telephone communication, when erroneous operations may easily occur, there is the advantage that it is possible to effectively prevent erroneous operations on the touch panel part 2.

In the mobile electronic device 1, when the display regions of the touch panel part 2 are bisected into a display region for the menu buttons receiving contact input and another display region, the main control part 10 preferably causes the confirmation button g to be displayed in the other display region (refer to FIG. 4 and FIG. 5). As a result, because it is possible to prevent erroneous operations on the confirmation button g (i.e., erroneous operations caused by similar factors as erroneous operations of the pressed menu button), there is the advantage that it is possible to effectively prevent erroneous operations on the touch panel part 2.

In this mobile electronic device 1, in a configuration comprising the receiver 7 used for telephone communication, the main control part 10 preferably causes the confirmation button g to be displayed at a position relatively far from the receiver 7 compared to the menu button c receiving contact input (refer to FIG. 4 and FIG. 5). As a result, because it is possible to prevent erroneous operations on the confirmation button g (i.e., erroneous operations caused by similar factors as erroneous operations of the pressed menu button), there is the advantage that it is possible to effectively prevent erroneous operations on the touch panel part 2.

Moreover, the mobile electronic device 1 comprises the timer B that has a prescribed set time. In addition to starting the timer B once the confirmation button g is displayed (steps ST07 and ST08), the confirmation button g executes a function corresponding to the menu button c receiving contact input when contact input on the confirmation button g is detected before the set time of the timer B is complete (negative determination in step ST15, positive determination in step ST09, and step ST11) (refer to FIG. 3). For example, in the present embodiment, the timer B has a set time of 5 seconds, and when the confirmation button g is pressed before the set time passes from when the confirmation button g is displayed, the function of the menu button c is executed.

In this configuration, a time limit (set time) is set for contact input on the confirmation button g, and it is possible to accurately detect whether contact input on the menu button c is intentional on the part of the user. As a result, there is the advantage that it is possible to effectively prevent erroneous operations on the touch panel part. For example, if the menu button c is pressed intentionally by the user, the confirmation button g is frequently pressed within a short time (set time). On the other hand, if the menu button c is pressed due to an erroneous operation, the confirmation button g will frequently not be pressed even if the prescribed set time has passed.

Moreover, in the mobile electronic device 1, when contact input on the confirmation button g is not detected before the set time of the timer B is complete, the main control part 10 deletes the confirmation button g and displays the menu buttons a-f at the first position on the touch panel part 2 (negative determination in step ST15, and step ST01 and step ST04) (refer to FIG. 3). For example, in the present embodiment, when the confirmation button g is not pressed even after the set time has passed, the confirmation button g is deleted (call initialization process) and the menu buttons a-f are displayed again. This displaying of the menu buttons a-f may be achieved by (a) in a configuration in which the menu buttons a-f are deleted when the confirmation button g is displayed, redisplaying the menu buttons a-f, or (b) in a configuration in which the menu buttons a-f are not deleted when the confirmation button g is displayed, maintaining the display of the menu buttons a-f.

In this configuration, when, for example, the menu buttons a-f are pressed due to an erroneous operation, the touch panel part 2 may be quickly returned to the initial screen (refer to FIG. 4). As a result, there is the advantage that the display on the touch panel part 2 may be appropriately maintained.

The mobile electronic device 1 comprises the timer B that has a prescribed set time. When contact input on the confirmation button g is detected before the set time of the timer B is complete, the main control part 10 may be set to display the confirmation button g again while also executing a function corresponding to the menu button c receiving the contact input when the contact input on the confirmation button g is detected (not illustrated).

In this configuration, in a configuration in which, for example, the menu buttons a-f are displayed across the entirety of the touch panel part 2, the intention of the user may be confirmed multiple times by displaying the confirmation button g multiple times. As a result, there is the advantage that it is possible to more effectively prevent erroneous operations on the touch panel part 2.

Moreover, the mobile electronic device 1 comprises the timer A that has a prescribed set time. Then, the main control part 10 starts the timer A after a call is started (step ST02), and when no contact input on the confirmation button g is detected before the set time of the timer A is complete, it prohibits contact input on the touch panel part 2 (negative determination in step ST09, positive determination in step ST12, and step ST14) (refer to FIG. 3). For example, in the present embodiment, when the confirmation button g is not pressed even after 1 minute (the set time of the timer A) has passed since the start of a call, contact input on the touch panel part 2 is prohibited.

In this configuration, when the prescribed time passes from the start of a call, contact input on the touch panel part 2 is prohibited even if an erroneous operation is performed. As a result, there is the advantage that it is possible to appropriately prevent erroneous operations on the touch panel part 2. In particular, by combining this control with the erroneous-operation prevention control provided by the display of the confirmation button g, there is the advantage that it is possible to more effectively prevent erroneous operations on the touch panel part 2.

As described above, the mobile electronic device according to the present invention is useful in that it is able to prevent erroneous operations on the touch panel part.

While at least one exemplary embodiment is presented in the foregoing detailed description, the present disclosure is not limited to the above-described embodiment or embodiments. Variations may be apparent to those skilled in the art. In carrying out the present disclosure, various modifications, combinations, sub-combinations and alterations may occur in regard to the elements of the above-described embodiment insofar as they are within the technical scope of the present disclosure or the equivalents thereof. The exemplary embodiment or exemplary embodiments are examples, and are not intended to limit the scope, applicability, or configuration of the disclosure in any way. Rather, the foregoing detailed description will provide those skilled in the art with a template for implementing the exemplary embodiment or exemplary embodiments. It should be understood that various changes can be made in the function and arrangement of elements without departing from the scope of the disclosure as set forth in the appended claims and the legal equivalents thereof. Furthermore, although embodiments of the present disclosure have been described with reference to the accompanying drawings, it is to be noted that changes and modifications may be apparent to those skilled in the art. Such changes and modifications are to be understood as being comprised within the scope of the present disclosure as defined by the claims.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device comprising:
a chassis;
a touch panel part that is exposed on the surface of the chassis and detects contact input from an external source, and displays display content corresponding to the contact input;
a main control part that controls the display content on the touch panel part; and
a communication part that realizes wireless communication, wherein if the communication part is in the middle of a communication process,
the main control part causes a prescribed menu button to be displayed at a prescribed first position on the touch panel part, and when a contact input on the menu button is detected, the main control part causes a prescribed confirmation button to be displayed at a second position that is on the touch panel part and is different from the first position, and when a contact input on the confirmation button is detected, the main control part executes a function corresponding to the menu button.

2. A mobile electronic device comprising:
a chassis;
a touch panel part that is exposed on the surface of the chassis and detects contact input from an external source, and displays display content corresponding to the contact input;
a main control part that controls the display content on the touch panel part;
an application control part that controls various application programs; and
a communication part that realizes wireless communication, wherein if the communication part is on standby and the application programs are not active,
the main control part causes a prescribed menu button to be displayed at a prescribed first position on the touch panel part, and when a contact input on the menu button is detected, the main control part causes a prescribed confirmation button to be displayed at a second position that is on the touch panel part and is different from the first position, and when a contact input on the confirmation button is detected, the main control part executes a function corresponding to the menu button.

3. The mobile electronic device according to claim 1, wherein, when a contact input on the confirmation button is detected while the communication part is in communication or on standby, the main control part executes a function corresponding to the menu button.

4. The mobile electronic device according to claim 1, wherein
the communication part that realizes telephone communication,
the main control part executes a function corresponding to the menu button when a contact input on the confirmation button is detected while the communication part is in communication or on standby.

5. The mobile electronic device according to claim 1, wherein, when the display region on the touch panel part is bisected into a first display region for the menu button receiving contact input and a second display region, the main control part causes the confirmation button to be displayed on the second display region.

6. The mobile electronic device according to claim 4, comprising a receiver used for the telephone communication, wherein
the main control part causes the confirmation button to be displayed at a position further from the receiver compared to the menu button.

7. The mobile electronic device according to claims 1, comprising a timer operable to set a prescribed set time, wherein
the main control part initiates the timer once the confirmation button is displayed, and when a contact input on the confirmation button is detected before the set time of the timer is completed, the main control part executes a function corresponding to the menu button.

8. The mobile electronic device according to claim 7, wherein, when a contact input on the confirmation button is not detected before the set time of the timer is completed, the main control part deletes the confirmation button and displays the menu button at the first position.

9. The mobile electronic device according to any of claims 1, comprising a timer operable to set a prescribed set time, wherein
when a contact input on the confirmation button is detected before the set time of the timer is completed, the main control part displays the confirmation button again, and executes a function corresponding to the menu button when a contact input on the confirmation button is detected.
